(19) United States
(12) Patent Application Publication
(10) Pub. No.: US 2007/0166690 A1
(43) Pub. Date: Jul. 19, 2007

(54) VIRTUAL COUNSELING PRACTICE

(76) Inventor: Bonnie Johnson, Bellingham, WA (US)

Correspondence Address: HUGHES LAW FIRM, PLLC, PACIFIC MERIDIAN PLAZA, SUITE 302, 4164 MERIDIAN STREET, BELLINGHAM, WA, 98226-5583, US

(21) Appl. No.: 11/616,413

(22) Filed: Dec. 27, 2006

Related U.S. Application Data
(60) Provisional application No. 60/754,367, filed on Dec. 27, 2005.

(51) Int. Cl. G09B 19/00

(52) U.S. Cl. 434/365; 434/236

(57) ABSTRACT

A virtual counseling practice. The practice enables a counselor trained to provide counseling to a patient to hold counseling sessions within a virtual reality world. A counseling server, a counseling application, and a counseling database, supplement the patient and counselor session in the virtual world. The counseling application provides communication tools. The communication tools supplement the counseling section through heightening of feelings, emotions, and other patient information during the session.

### RELATED APPLICATIONS

This application claims priority benefit of U.S. Ser. No. 60/754,367 filed Dec. 27, 2005.

### BACKGROUND

U.S. Pat. No. 6,503,085 (Elkind) discloses the use of virtual reality on a desktop computer format to diagnose executive dysfunctions. The neuropsychological dysfunctions include executive dysfunctions. The individual interacts with computer-generated simulated environment in a predetermined testing format. The test subject is wired into physiological monitoring machines to monitor respiration, heart rate, blood pressure, skin changes and the like to gather data about the individual's outward manifestations when having to make decisions which indicate the dysfunctions within the virtual reality environment.

U.S. Pat. No. 6,425,764 (Lamson) discloses a virtual reality immersion therapy for treating psychological, psychiatric, medical, educational and self-help problems. Full immersion into the three-dimensional virtual reality environment is provided by using goggles, head mounted displays, or other projection type equipment. Voice, music and sound or other forms of physiological stimulation and feedback are provided. Navigation is provided through the use of a handheld grip joystick or the like. Virtual therapy is used as described in Column 13 at line 21, which includes the assessment of cognitive, emotional and physiological functioning before, during and after treatment of psychiatric conditions.

U.S. Pat. No. 6,186,145 (Brown) discloses a method for diagnosis and treatment of psychological and emotional conditions using a microprocessor based virtual reality simulator. The concept uses a computer program held within the computer-based microprocessor which creates a virtual reality simulator. A video display represents the 3-D images and the virtual reality is designed for a specific diagnosis of the patient's psychological and physiological disorders. Referring to Column 9 at line 16, the microprocessor based unit connected to the audiovisual display has a display which allows for three or more dimensions. The patient can operate the display by using a joystick which has either a blood glucose monitor on it or a respiratory flow meter. The patient elicits responses through the use of the joystick and/or control unit which is recorded in the microprocessor based unit to provide diagnostic measures relating to a particular psychological condition.

US 2005/0053902 (Vladimirovich) this patent application discloses a method for working out the behavioral strategy of a player using cognitive virtual reality, and a device for carrying out said method and an information carrying medium for said device. A virtual reality three-dimensional game is provided where a user or player is tracked from inception of entering into the game. Throughout the game the player makes various choices which are correlated to a psychological profile of the player's personality matrix. This system and method records a player's actions in the virtual reality environment and psycho-physical qualities of the player's personality are transferred onto the characters and objects of the game.

US 2004/0215488 (Hein et al.) this patent application discloses a therapy system and method where a patient computer is connected to a therapy sensor which is then connected to a therapist computer via the network. A communication module is provided during a therapy session which enables the release of at least one therapy program preloaded on the patient computer. After this, a therapy plan is created which is transmitted from the therapist computer to the patient computer. The therapy plan is executed by the patient on his computer. The therapist, as referred to in paragraph 98, is in the position to average a general choice of exercises for the patient. The neuropsychological orthopedic training programs within the therapy system can be chosen. The patient accesses the prescription or therapy program by switching on the patient computer, as discussed in paragraph 105, and is asked to insert his identification card into the card slot of the ID module. After successful identification, messages from the therapist to the patient are displayed on the message screen. The patient can send the therapist a written reply as to the various questions. The patient can then choose between different therapy programs suggested by the therapist. After successful therapy training, the patient receives a note concerning the difficulty level of the just finished therapy program.

US 2004/0175680 (Hlavac et al.) is a US patent application for artificial intelligence platform which discloses the way to deploy interactive characters powered by artificial intelligence. This platform permits the creation of a virtual world populated by multiple characters and objects interacting with one another so as to create a lifelike virtual world which provides an interesting and powerful experience to the user. Referring to paragraph 110, the software system determines what a given creature does at any given moment which is the behavior component, and how that creature feels, which is the emotion component, and how the creature's past experience affects its future actions, which is the learning component. Referring now to paragraph 137, the artificial intelligence engine accumulates a continuous flow of information. The characters sensory system gathers stimuli by sampling the state of the virtual world around the character and any input from a human user, and takes cues from the story mentioned as well.

US 2004/0121295 (Stuart et al.) is a US patent application which discloses a method and system for using a virtual environment to provide information on using a product. The virtual customer utilizes the promoted product by receiving input control signals from the user indicating movement of the virtual customer through the virtual environment. Interactions are rendered between the virtual customer and the virtual environment in response to the input control signals to enable the user to virtually experience how the promoted product is capable of impacting daily activities of the user and to promote the product.

US 2003/0207237 (Glezerman) discloses a US patent application for an agent to guide children in a virtual learning environment. The controlled virtual environment is constructed by software when executed in a computer, and a guardian establishes parameters for the user. Information is stored with regard to the user's interactions and movements within the controlled environment. The user can select a virtual environment to be displayed in the computer. An invisible Buddy is provided who can be used to provide guidance by communicating to the user. The Buddy being an intelligent agent software component, then engages the child in the activities that satisfy the constraint goals provided by the guardian.

US 2003/0059750 (Bindler et al.) discloses a US patent application for automated and intelligent network based psychological services. This concept provides a modulated approach for implementing online psychological services. The services are made up of modules consisting of specific techniques, procedures, tests or skills. Everything is customizable to meet the needs of a client. Clients are able to assemble a set of modules to come up with the protocol for treating a specific disorder.

US 2003/0004752 (Banerjee et al.) discloses a US patent application for a method and apparatus for web-based multiparty counseling. This concept provides for counseling over the Internet. The server provides for establishing control and tracking of sessions which may include a plurality of clients or counselors. Each counselor may be simultaneously involved in multiple sessions and the individual patient may not be aware that the counselors are engaged in one or more sessions.

### BRIEF DESCRIPTION OF THE DRAWINGS

FIG. 1 is a schematic of the virtual counseling world system 10;

FIG. 2 is a schematic diagram of the virtual counseling world server in correspondence with the virtual counseling client server;

FIG. 2A is a schematic diagram of an alternative embodiment of the virtual counseling world server;

FIG. 2B is a schematic diagram of the administration application;

FIG. 2C is a schematic diagram of the patient application;

FIG. 2D is a further schematic diagram of the patient application;

FIG. 2E is a schematic diagram of the provider application;

FIG. 2F is a further schematic diagram of the provider application;

FIG. 2G is a further schematic diagram of the provider application;

FIG. 3 is a system diagram of the virtual counseling world application, database, and objects;

FIG. 4 is a system diagram of the virtual counseling world patient data application, database, and objects;

FIG. 5 is a system diagram of the virtual counseling world client application, database, and objects;

FIG. 6 is a plan view of the virtual world island;

FIG. 7 is a diagram of the welcome area entrant's objects;

FIG. 8 is a diagram of the personal area objects;

FIG. 9 is a diagram of the professional services objects;

FIG. 10 is a diagram of the peer-to-peer area objects;

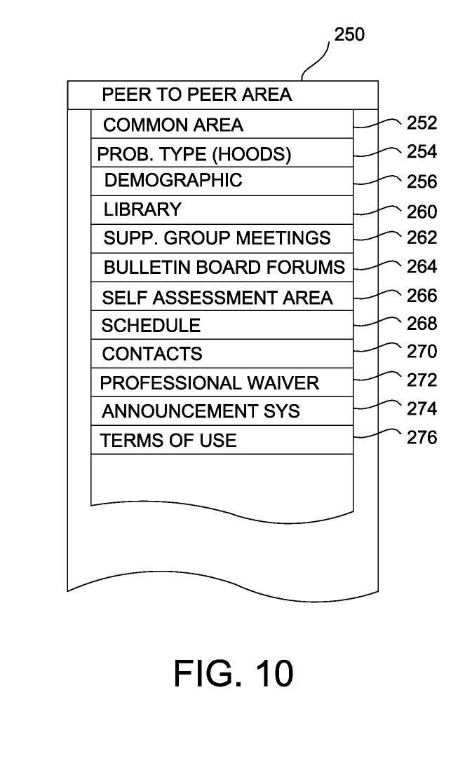

FIG. 11 is a flow diagram of the assessment area process;

FIG. 12 is a flow diagram of the counseling session process;

FIG. 13 is a plan view of the instant virtual counseling world assessment session environment.

### DESCRIPTION OF THE PREFERRED EMBODIMENTS

Generally speaking, this concept deals with the field of psychology, and specifically with mental health counseling services. The concept creates efficiencies in corresponding between counselor and patient and making use of technologies to create effective meeting spaces for exemplary counseling sessions as well as creating meeting spaces for peer-to-peer meeting sessions between patients and research spaces for patient and counselor to effectively explore their cases. The concept uses various forms of three-dimensional virtual reality online worlds to create various counseling efficiencies.

This concept enables the users, which include the counselors and the clients or patients, to use tools to engage one another and communicate various emotions, feelings, and information which are enhanced by the present system.

Communication settings are made to set the desired mood or environment the counselor wishes to enhance during the session, and these environments can be modified through the use of environmental tool settings. These settings can be based on criteria from which the patient has input prior to the meeting with the counselor or vice versa.

The environments themselves can change during the meeting depending on the course of the direction of the meeting; also the users can cloth themselves in different types of Avatar bodies or skins to convey a certain impression. This way the patient can more easily represent himself and such a “clothing” can provide a sense of confidentiality, privacy, and comfort.

The system has various software tools or objects which enable the counselor and client to interact and effectively convey various emotions, feelings and information. This communication makes the counseling session effective and efficeint from a time and space viewpoint. The practice has voice, text, Emoticons, and other facial and body language characteristics which enable the counselor and the patient to effectively communicate their mental health and emotional health states.

The system also has the ability to take in precursor information such as the type of help the client believes he or she thinks they may need so that the counselor can effectively prepare for the session. The type of meeting environment as previously mentioned can be scripted, the ability to record the sessions for historical, mental health, and physician recordation purposes so that the meetings can meet the National Institute of Mental Health mandates for professional standards as well HIPPA compliance.

Within the system, various self help areas enable like-minded patients to interact with one another; these include list serves, peer-to-peer type meeting rooms, and other patient rooms. The system also includes research and storage rooms for various patients to further research their own cases which than can be brought into the counseling session as desired.

A detailed discussion of the one embodiment will now be provided. It should be noted that although the implementation of the this embodiment utilizes a centralized server with a plurality of client servers scattered throughout the Internet, the present concept can be implemented on a client side server or implemented on a localized central server.

The present system is currently configured for mental health practitioners. An alternative embodiments, the present system can be modified to serve other professional service industries, enabling the professional service provider to practice in a virtual environment utilizing similar custom toolset's. For example, counseling for other types of doctors, lawyers, accountants, consultants, architects, engineers and like. In such an alternative embodiment, and as will be described in detail below, the patient would be similar to a counselee, a patient application would be similar to a counselee application, and patient objects in a patient database would correlate to counselee objects in a counselee database.

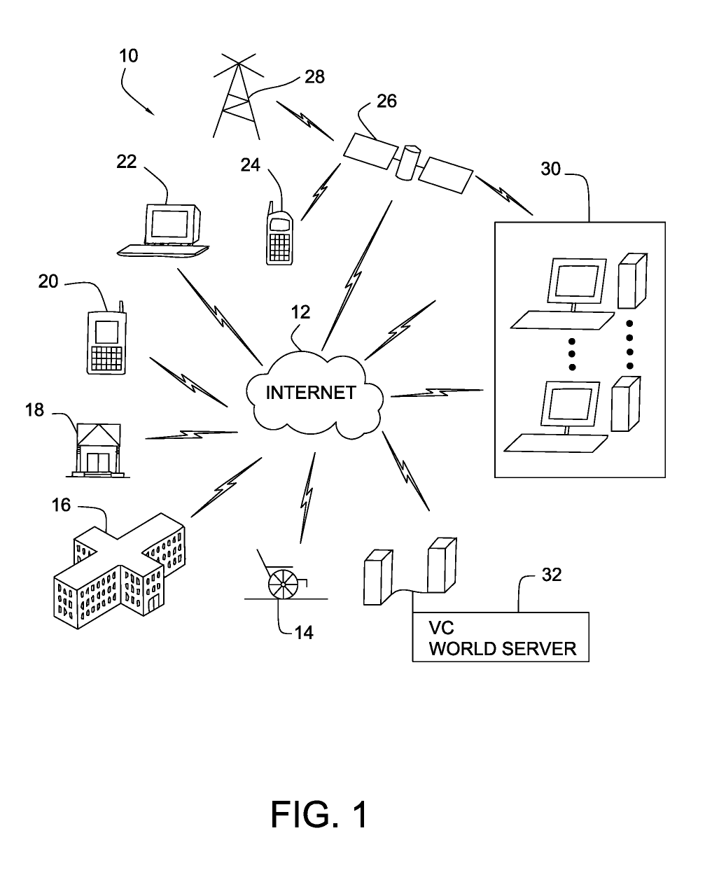

A brief discussion of the arrangement of the network and the Internet will now be provided. Referring now to FIG. 1, the virtual counseling world system 10 is shown where a plurality of devices are connected to one another via the Internet 12. These devices include retirement facilities 14, hospitals and physicians offices 16, schools 18, personal digital assistants 20, desktops 22, a variety of wireless devices including cell phones 24 which are connected via land-based wireless systems 28, and satellite wireless systems 26. Furthermore, intra-networks 30 are connected to the Internet which can then access, and depending on the platform, the virtual counseling world server 32 to implement the present concept.

In order to enable the present concept, a plurality of servers are provided which enable the applications to run on the servers and access the databases. Servers can include Microsoft SQL Server as well as other systems such as Linux.

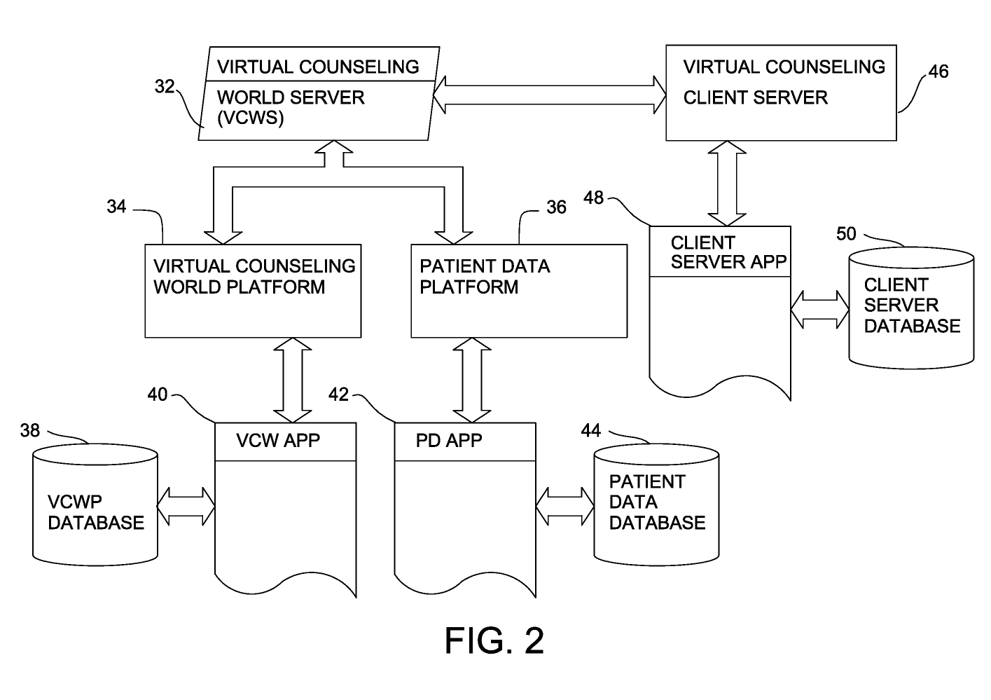

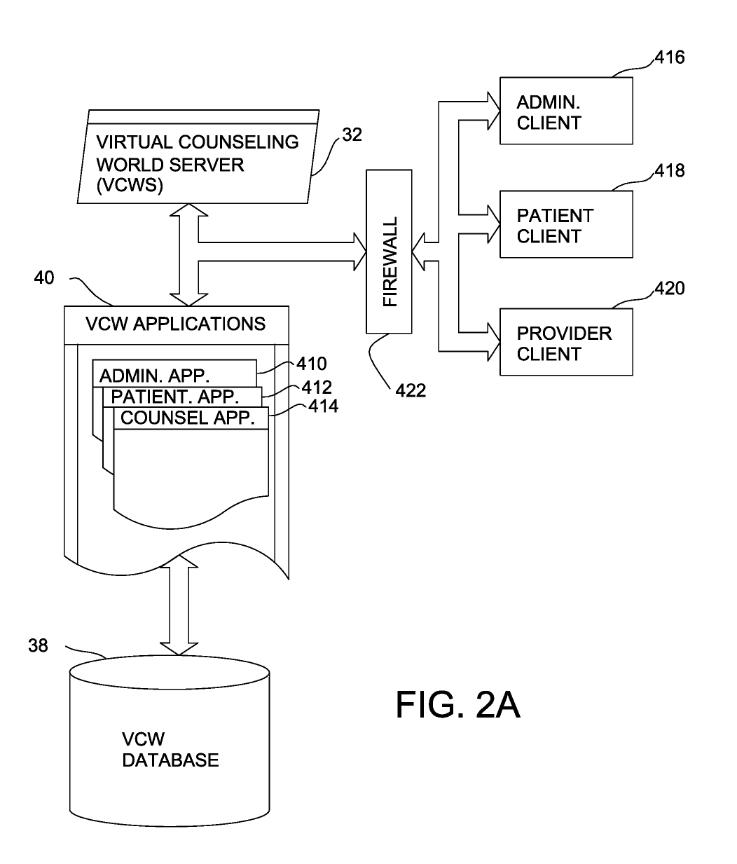

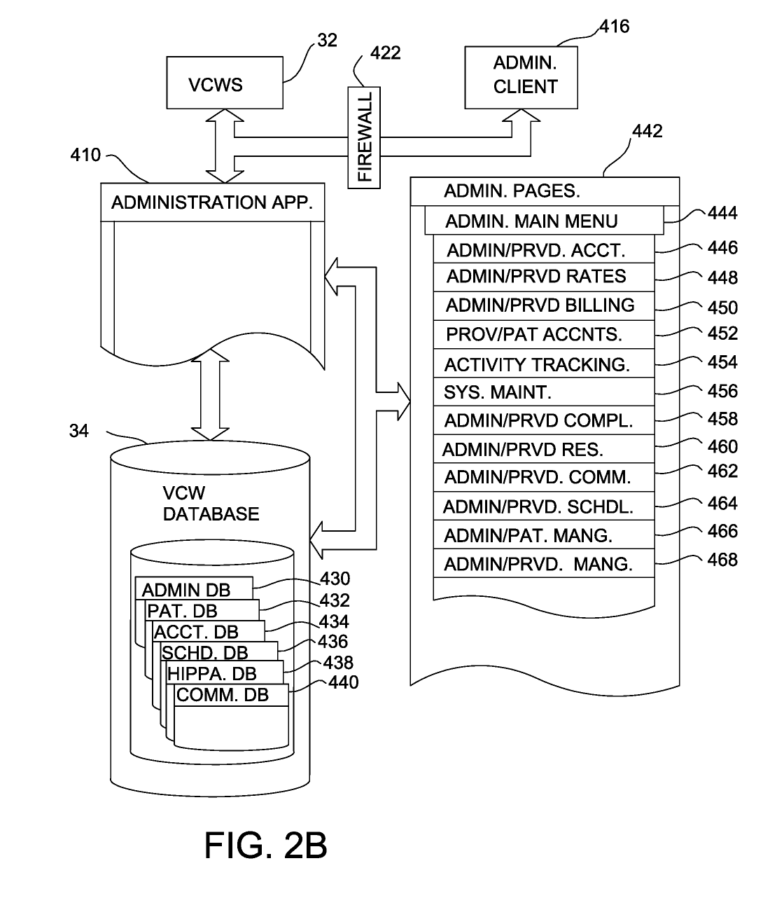

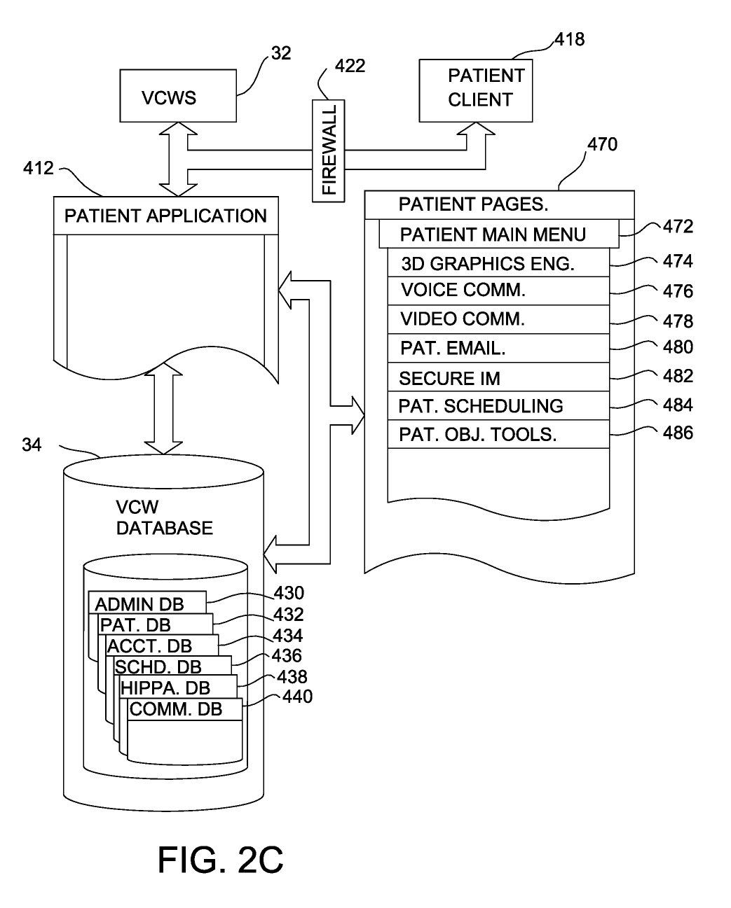

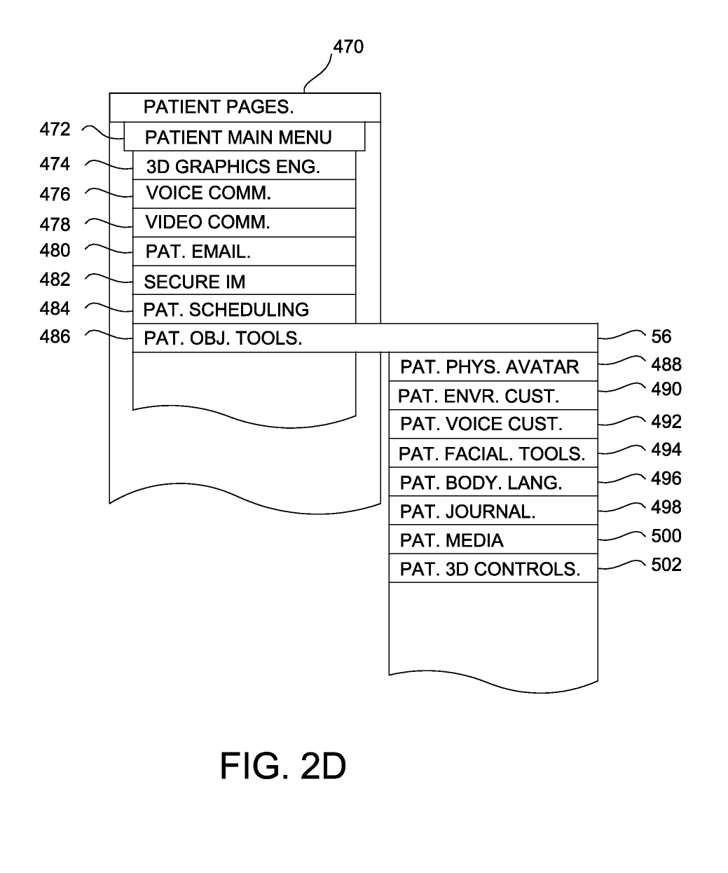

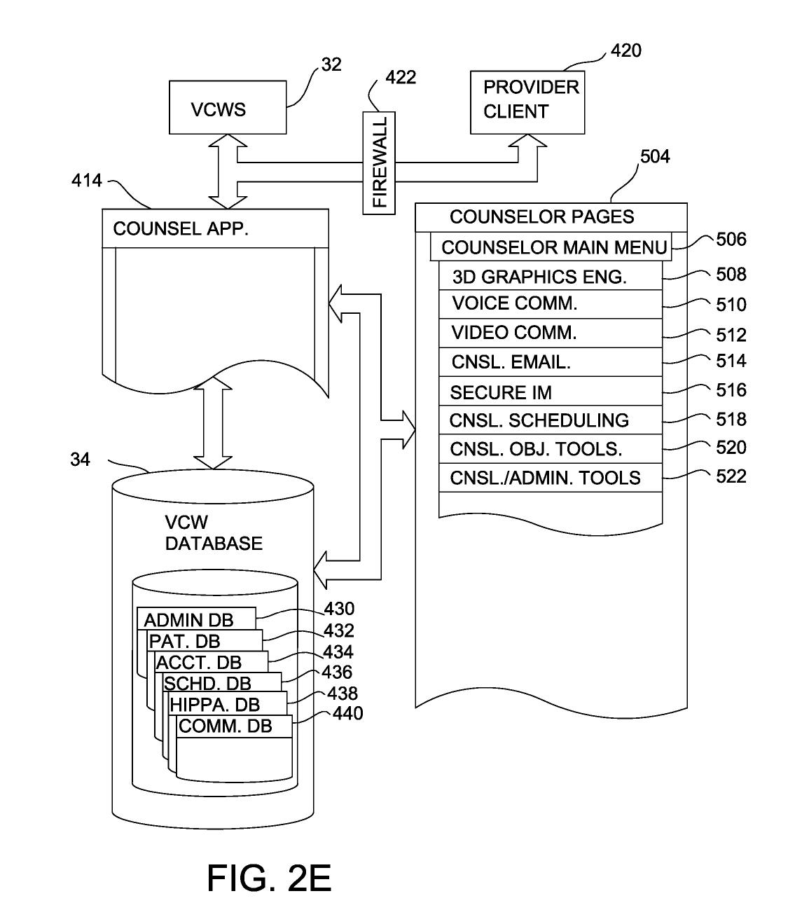

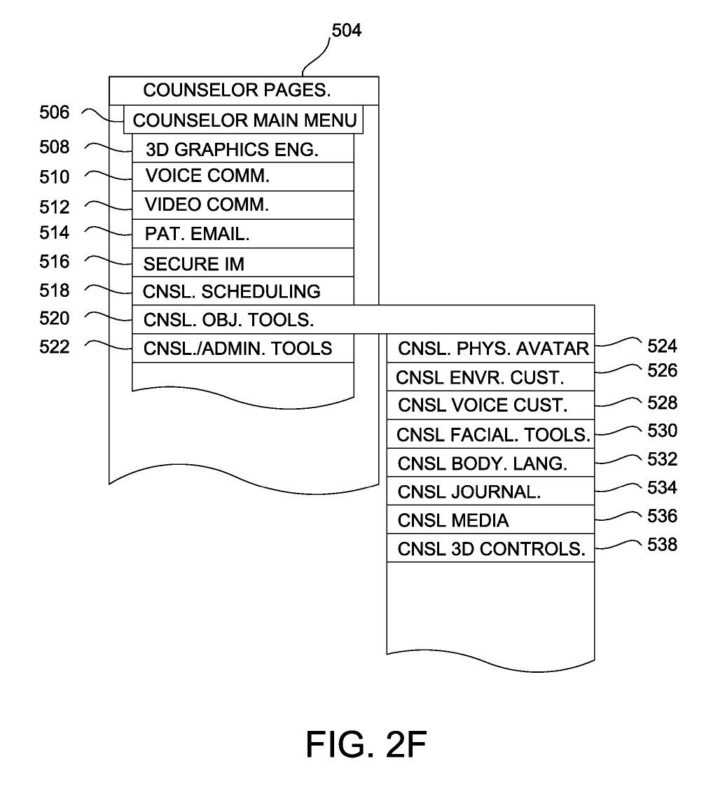

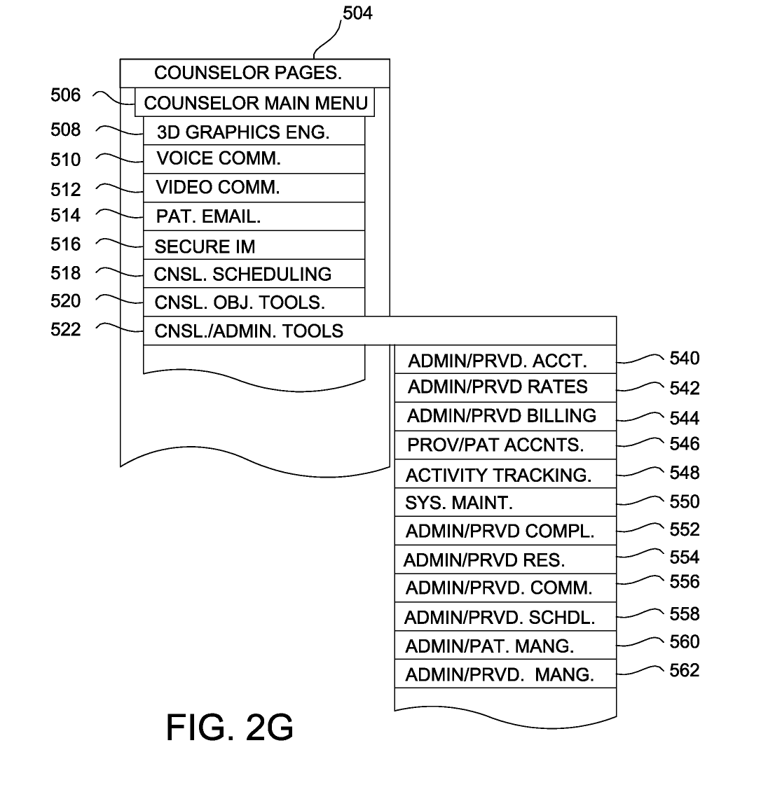

Referring now to FIG. 2, the virtual counseling world server 32 can be provided on one or more machines and mirrored, but the first embodiment is that the world server provides support for two distinct platforms, a virtual counseling world platform 34 and a patient data virtual world counseling platform 36. The previously-mentioned devices that are connected to the Internet can download in some form a client server application 48 and have a thin client virtual counseling client server 46 located on their, for example, desk top 22 as seen in FIG. 1. This enables the client side information to be stored on a client server database 50, which is information specific to each particular client.

Because of HIPPA compliance concerns regarding privacy 20 and security, issues, the patient data information may be kept on a separate platform as previously discussed. This first embodiment separates the virtual world counseling session information and other mental health related interactions as they occur in the virtual world from the patient data stored in the electronic medical records/practice management server software, which may be accessed by a variety of mental health providers, physicians, nurse practitioners, physician's assistants, nursing staff, insurance companies, HMOs, EAP's, school counselors, correctional officers, military personnel, human resource departments and other physical world organizations possibly needing access to data compiled by the counselor while interacting with patients in the virtual world environment. From this state, data is stored in a formal and consistent medical record which is formatted to comply with all relevant EMR regulations and meets standards for patient data sheets used in communicating with physical world physicians and other authorized professionals involved in patient care.

These databases are easily accessible and organized so that all authorized persons can access it as needed to review the patient's care, make treatment recommendations and modifications, and communicate with other providers in a paperless and rapidly distributed manner.

The virtual counseling world platform 34 supports a virtual counseling world platform database 38 as well as a virtual counseling world application 40. The patient data virtual counseling world platform 36 supports a patient database 44 as well as a patient data application 42.

Examples of similar virtual worlds which are currently in use would be worlds such as Everquest, Second Life, and other such world building and socializing games which have become popular in recent years. In order to implement these system intensive graphics and physical engines, the virtual world or the virtual counseling world application 40 has to enable and load specific objects for its run time.

It in alternative embodiment, referring to figure to 2A, the virtual counseling world server 32 hosts a single set of applications running from a database, the applications providing various forms of application interfaces to clients through a firewall. For example, the virtual counseling world server 32 hosts a number of virtual counseling world applications 40 which include an administration application 410, patient application 412, and a counselor application 414. These applications are interoperable with a virtual counseling world database 38, to be discussed further below. An administration client 416 can access the administration application 410 through a firewall by utilizing a secure socket link connection. In the same way, patient client 418 can access the patient application 412 and the provider client 420 can access the counselor application 414. The applications can be initialized in various instances and configurations on the previously mentioned clients depending on the end users desired use or control settings by the administration client 416.

For congruency in discussion, a more detailed discussion of this second alternative embodiment will be provided after a detailed discussion of the first embodiment.

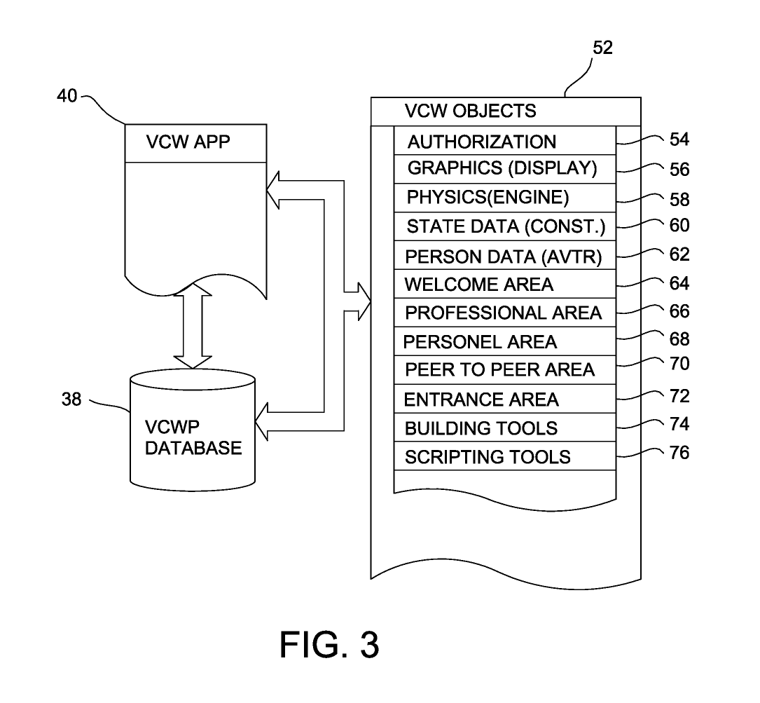

Referring now to FIG. 3, the virtual counseling world application 40 can access the virtual counseling world database 38 and can initialize various virtual counseling world objects 52 depending on the desired system need. These various objects include an authorization object 54, graphics or display objects 56, physics engines 58, state data objects or constructs 60, person data objects or Avatars 62, a welcome area object 64, a professional area object 66, a peer-to-peer area object 70, entrance area objects 72, building tool objects 74, and scripting tool objects 76.

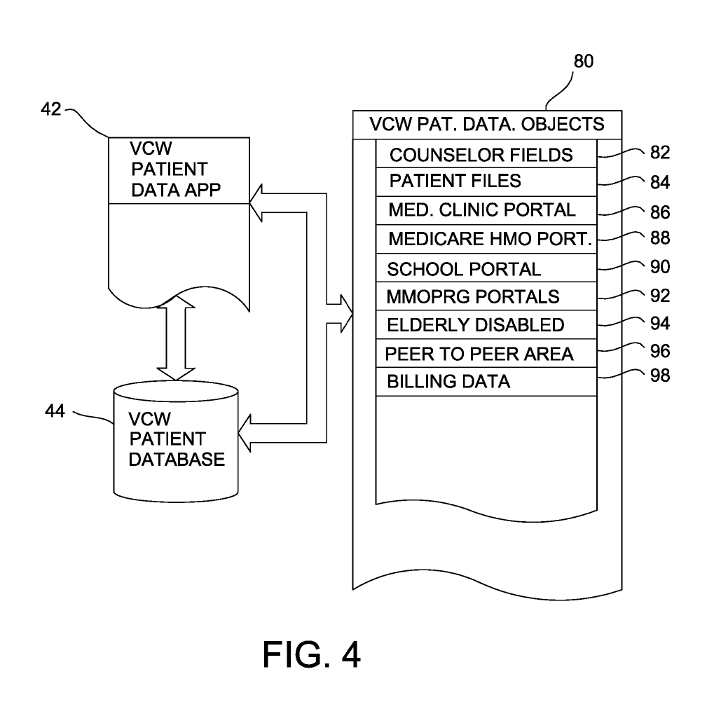

The virtual counseling world patient data application 42 as seen in FIG. 4, can access a separate virtual counseling world patient database 44 and initialize various virtual counseling world patient data objects 80. These objects include counselor files 82, patient-to-file objects 84, medical clinical portals 86, medical HMO portals 88, school portals 90, MMOPRG portals 92, elderly disabled object portals 94, peer-to-peer area portals 96, and billing data objects 98.

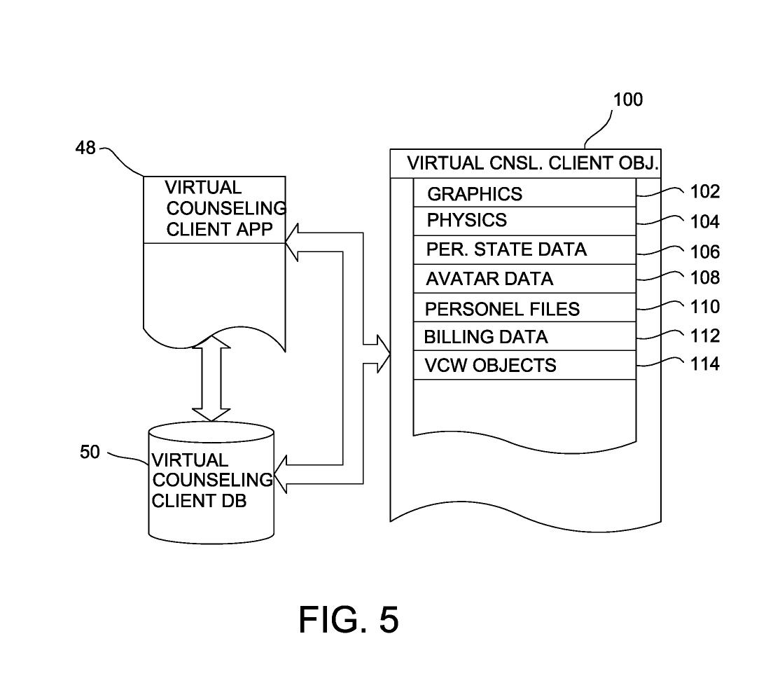

Because the nature of the virtual world is such that individuals need to access the virtual world through separate disparate clients, a certain amount of information and data needs to be kept on each client to expedite the process. Referring to FIG. 5, the virtual counseling client application 48 is supported by the virtual counseling client server 46 as seen on FIG. 2, and can access the virtual counseling client database 50 and initialize various virtual counseling client objects 100 as desired to operate within the virtual counseling world environment as will be discussed below.

In order to effectively operate, the virtual counseling client objects 100 included is a graphics objects set 102, physics objects set 104, personal state data objects 106, Avatar data objects 108, personal file objects 110, billing information or data objects 112, and other cross-platform virtual counseling world objects 114 which may be desired for backup purposes or to run the entire system on the local client if desired.

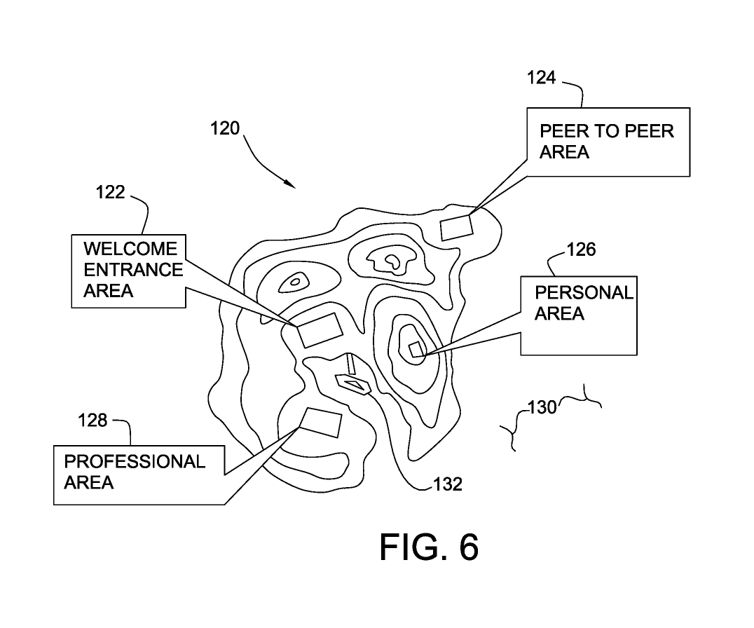

With the virtual counseling world system 10 accesible in the virtual world, the virtual world enables the users of the virtual world to acquire “real estate” such as small predetermined lots such as an acre or two or actual virtual world Islands 120 as seen in FIG. 6. Citizens of the virtual world or residents of the virtual world can then visit for example the virtual world Island 120 and enter into various virtual spaces as will be discussed below.

For security purposes, the virtual world Islands 120 in one particular embodiment is only accessible by patients authorized to port or enter into the island.

For example, a resident or client or patient enabled to access the virtual world Island 120 as depicted in FIG. 6, may first enter the welcome entrance area 122. After familiarizing herself and registering, the patient may wish to visit various operational areas within the virtual world Island 120. They also include a professional area 128, a peer-to-peer area 124, and a personal area 126. Generally speaking, the welcome entrance area 122 provides an overview as well as entrance to private and public spaces as well as registering and understanding the various services that are provided at the virtual counseling world Island 120.

The professional area 128 is where the therapists, doctors, and other staff personnel hold their meetings with the patients, as well as perform various functions for maintaining the operation of the facility.

The peer-to-peer area 124 is a public meeting space designed specifically for various types of patient groups to meet and interact to discuss their various issues and/or problems.

The personal area 126 is designed for individuals to implement their own personal patient place to keep files, develop environments, do research, and other types of patient therapy activities.

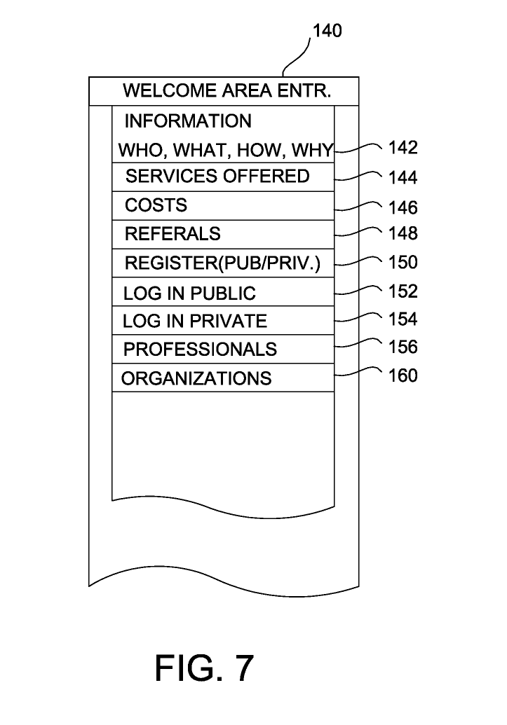

The welcome area or entrance area 122 is supported by a plurality of objects and/or informational settings as seen in FIG. 7. The welcome area entrance 140 includes information object on who, what, how, and why as seen in 142. Also the various services provided for the virtual counseling world are shown in a services offered object 144. Clients and other individuals may wish to know the costs involved with such a service, which is displayed in costs object 146.

Other welcome area entrance objects include referrals 148, registration including public and private 150, a public login 152, a private login 154, an entrance for professionals 156, and a section for organizations 160. The welcome area entrance 140 is the main gateway into and out of the virtual counseling world island 120 as referred to in FIG. 6.

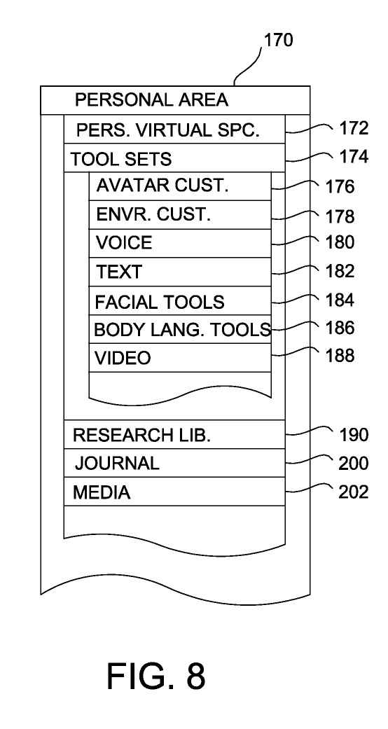

Patients or individuals visiting the virtual counseling world island 120 may wish to set up their own personal area 126. Various personal area objects 170 are provided for performing such tasks as seen in FIG. 8. These objects include allocating a virtual personal space 172, and utilizing various tool set objects 174 for customization.

It is intended for the patient's to utilize and prepare for the sessions with the counselors. This preparation includes using Avatar customization tools 176, environment customization tools 178, voice tools 180, text based communication tools 182, facial based communication tools 184, body language communication tools 186, and video tools 188. Also each personal area includes information accessible by research library objects 190, journal objects 200, and media objects 202.

Still referring to FIG. 8, by utilizing the virtual world counseling services the patient and counselor can use specialized communication tools designed for avatar to avatar communication. For example, Avatars can express emotions through facial and body language as well as voice and text to give a unique description of their feelings and emotional state during the counseling session. The tool set objects 174 have customized voice, text, facial, and body language tools to fully enable the patient and therapist or counselor to communicate with one another.

Although this is not a comprehensive list, the facial tools, voice tools, and body language tools accessible in the tool set objects 174 can be utilized to express the following feeling word vocabularies. These feelings then shown in a feeling object tool set through a combination of Avatar body choice, clothing choice, facial features, body language, textual communication, voice communication, environment choice, etc. . . . These feeling objects include strong intensity, feeling objects such as: happy/sad, hurt/angry/scared, confused, excited, hopeless, furious, fearful, bewildered, elated, sorrowful, seething, panicky, trapped, exuberant, wounded, enraged, shocked, troubled, ecstatic, drained, hostile, overwhelmed, demobilized, terrific, defeated, vengeful, startled, stagnant, jubilant, exhausted, incensed, intimidated, ambivalent, alive, crushed, hateful, desperate, energetic, worthless, humiliated, frantic, enthusiastic, dejected, sabotaged, terrified, loved, rejected, betrayed, vulnerable, empty, repulsed, hopeless, miserable, jealous, distraught, pissed off, and bitter.

Other feeling objects which can be expressed by either voice, facial expression, body language, and text, for moderate intensity-type feeling objects include: happy/sad/hurt/angry scared, confused, valued, depressed, resentful, tense, awkward, gratified, disappointed, disgusted, threatened, puzzled, encouraged, inadequate, smothered, afraid, disoriented, optimistic, dismal, frustrated, uneasy, foggy, joyful, unappreciated, stifled, defensive, proud, discouraged, offended, insecure, cheerful, distressed, skeptical, assured, disillusioned, controlled, apprehensive, grateful, lonely, peeved, suspicious, appreciated, isolated, annoyed, perturbed, confident, alienated, agitated, ashamed, respected, abandoned, irritated, admired, regretful, accepted.

Other feeling objects which can be expressed by either voice, facial, body and other feelings of mild intensity include: happy, sad, hurt, angry, scared, confused, content, lost, uptight, reluctant, bothered, relaxed, distant, dismayed, anxious, undecided, glad, resigned, shy, uncomfortable, satisfied, nervous, perplexed, peaceful, timid, unsure, calm, concerned, doubtful, tranquil, worried, and pleased.

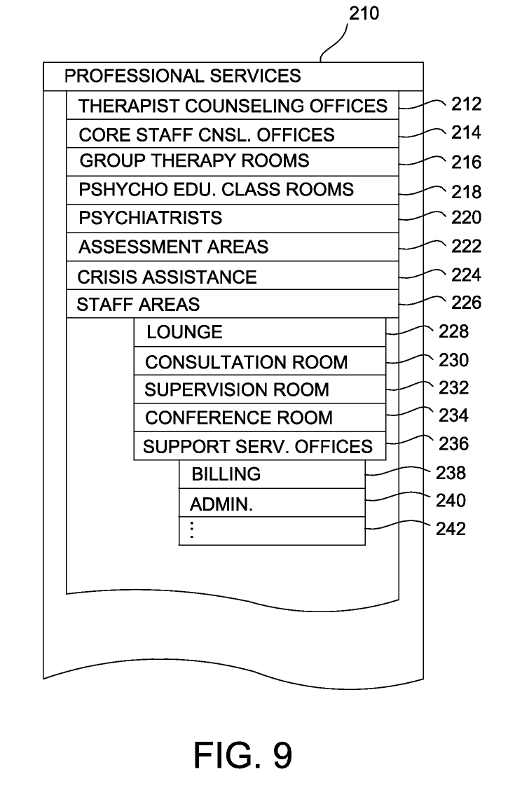

Many activities occurring on the virtual counseling world island 120 in this particular embodiment can occur at the professional area 128. Thus a large number of the activities will be supported by various professional services objects 210 as seen in FIG. 9.

Just like any physical office, a professional services area 128 needs areas to function. These areas are embodied in the professional services objects 210. They include a therapist counseling offices object 212, a core staff counseling offices object 214, a group therapy room set of objects 216, a psychological educational set of classrooms and objects 218, psychiatrist rooms 220, assessment areas 222, crisis assistance areas 224, staff areas 226, lounge areas 228, consultation room 230 for the staff, supervision room 232, conference room for staff 234, support services offices 236, these offices including billing services 238, administration services 240 and other functions as desired 242.

Similarly, a peer-to-peer area 124 as seen in FIG. 6 is supported by a series of peer-to-peer area objects 250. These include common areas 252, problem type or hoods 254, demographics 256, library areas 260, support group meeting areas 262, bulletin board forms 264, self-help assessment areas 266, schedule areas 268, contacts 270, professional waiver areas 272, announcement systems 274, and terms of use area 276. In order for individuals to access the peer-to-peer area 126, they will have to first agree to the terms of use 276 as well as the professional waiver 272.

As previously mentioned, much of the time using the virtual counseling world island 120 in the particular embodiment will be in the Avatar to Avatar and patient-to-therapist communications as well as the patient-to-patient communication in either a one-on-one setting or a group therapy setting.

The communication can occur at multiple points within the virtual counseling world; depending on the world set up, the effective communication can occur at the peer-to-peer area 124 as seen in FIG. 6, the professional area 128, as well as the welcome entrance area 122. It is also possible that patients would be able to invite other avatars into their personal areas 126 for communication purposes.

In the previously mentioned second embodiment, off-the-shelf virtual reality platforms such as secondlife.com are used so that the counselor's can provide virtual reality professional counseling services. The appearance of the three-dimensional virtual reality world platform along with additional administration applications, provider applications, and patient plug-in applications to be discussed below, enable the users to have a sense of being virtually presents in the environment. This in turn facilitates the counseling experience.

Access to the platform is established by creating a user account in the virtual world, downloading some user specific client based software onto the users client computer. Patients and counselors can create graphical representations of themselves as previously discussed by adopting avatars. The professional counseling services are established on a virtual world Island 120 as previously seen in FIG. 6.

To heighten the counseling experience, a number of in world plug-in application devices, and administration and counselor applications are provided.

Refering again to FIG. 2A, the virtual counseling world server 32 can be maintained within the server side of the virtual world such as the second life site, or can be maintained on a separate distinct server farm depending upon the desired security requirements and precautions as well as depending upon the ability of the virtual reality world to provide the needed security requirements.

Either way, the virtual counseling world server 32 as mentioned above, maintains a number of virtual counseling world applications 40. Detailed discussion of each application will not be provided.

The administration application 410 as see in FIG. 2B enables the individuals providing the virtual world Island 120 as previously mentioned in FIG. 6, to host the professional counseling services. The administration application is initialized from the virtual counseling world database 38 and the application 410 draws from a plurality of sub-databases including administration database 430, patient database 432, an accounting database 434, a scheduling database 436, a HIPPA compliance database 438, as well as a communications database 440.

These databases hold objects and classes of objects for creation of various sub-components as part of the administration application 410 as well as the patient application 412 (FIG. 2A), and the counselor application 414. Referring back to FIG. 2B, the administration pages 442 is one component initialized from the virtual counseling world database 38 to create the various components of the administration application 410.

The administration pages 442 has an administration main menu page 444. The menu page 444 can in one form be initialize as an administration specific graphic user interface within the virtual world, or can be accessed through a standard web page using active server pages for example, as well as exectued through a standard microsoft GUI application interface.

Nonetheless the component functionality includes administration and provider account maintenance 446 and administration provider rates 448. This particular rate page 448 enables the administration to set or keep tabs on provider rates, the provider being counselor providing services for the patients.

Further, there is also administration provider billing object 450, provider patient account object 452 which enables the administrators to review some or all of the provider patient accounts. Also included is an activity tracking object page 454, an overall system maintenance object page 456, administrator/provider compliance object page 458. This particular compliance page 458 enables administrators to send reports on behalf of the counselor/provider's to the various governmental agencies.

Also included in the administration application is an administration provider resources page 460 which enables the providers or counselors to access the administration preset resources maintained by the administration for providers benefit.

There are also communication tools provided through implementation of the administration provider communication page 462, as well as enabling and disabling various scheduling tools through the administration provider scheduling page 464. If for example a provider is no longer able to provide the particular counseling service, the administration or administrator can take over or reassign those particular services through the use of the administration patient management page 466.

Lastly, an administration/provider management page 468 is provided for other functionality which stems from the counseling practice.

Because most of the patient use of the virtual counseling world server 32 as seen in FIG. 2C will be in the virtual world itself, the patient application 412 can run from the patient client 418 or it can be run as a web based browser or GUI maintained within the virtual world itself. However the patient application 412 is run, it is geared more towards the implementation of the patient operation in the virtual reality setting. The patient application 412 accesses the as needed virtual counseling world database as well as the sub-databases as previously discussed, to implement various patient pages 470. These patient pages 470 include patient main menu 472, three-dimensional graphic engine component 474, voice communication pages 476, video communication pages 478, patient e-mail or textual communication 480, secure instant messaging 482, patient scheduling 484, and patient object tools 486.

During a patient's in world session, the patient will move three-dimensionally in world and correspond with other patients and counselors. Viewing is through a third person, first person, or top down view of the patient and it's surroundings in world as seen through the GUI. Nonetheless, the patient application 412 is with executable while the patient is moving through the world in either of these first person, third person, or top down view arrangements. The patient application 412 adds additional menu options to the standard GUI through tiled menus, pulldown menus, quick keys, mouse keys, peripherals enabling touch, voice, visual or mental commands to create a more virtually there presense.

On the patient main menu page 472 the patient object tools 486 as seen in FIG. 2D include options for customization and utilization of the patient communication and physical representation properties. These include patient physical avatar 488, patient environmental customization object 490, patient voice customization 492, patient facial tools 494, patient body language 496, patient Journal object 498, patient media objects 500, and patient 3D control object 502.

The counselor application 414 and is seen in FIG. 2E, has the functionality and accessibility of the patients application objects as well as the administration application objects.

The counselor application 414 has accessibility to the virtual counseling world database 34 as well as all of the sub-databases as previously mentioned above, so that the various objects and/or pages can be initialized in the counselor pages 504. These include a counselor main menu page 506, three-dimensional graphics engine object 508, voice communication object 510, video communication object 512, a counselor e-mail communication object 514, a secure instant messaging object 516, counselor scheduling object 518, counselor objects tools 520, and counselor administration tools 522.

Referring to FIG. 2G, the counselor must have access to the administration application and/or site, therefore a number of counselor administration tools 522 are provided in the counselors application main menu 506. These include an administration provider account maintenance object 540, an administration provider rates object 542, administration provider billing object 544, a provider patient accounts maintinence object 546, activity tracking object 548, various system maintenance control objects 550, administration provider compliance object 552, administration provider resource objects 544, administration provider communication objects 556, administration provider scheduling object 558, administration patient management objects 560, and administration provider management objects 562.

Lastly, the counselor also may communicate with the patient in the virtual reality world. To supplement and facilitate this communication, counselor object tools 520 are provided. These counselor object tools include counselor physical avatar object 524, counselor environmental customization objects 526, counselor voice customization objects 528, counselor facial tool objects 530, counselor body language object 532, counselor journal objects 534, counselor media objects 536, and counselor three-dimensional controls 538.

To give an example of the typical process which may occur during an assessment type of situation between a therapist and a client, the process is described below.

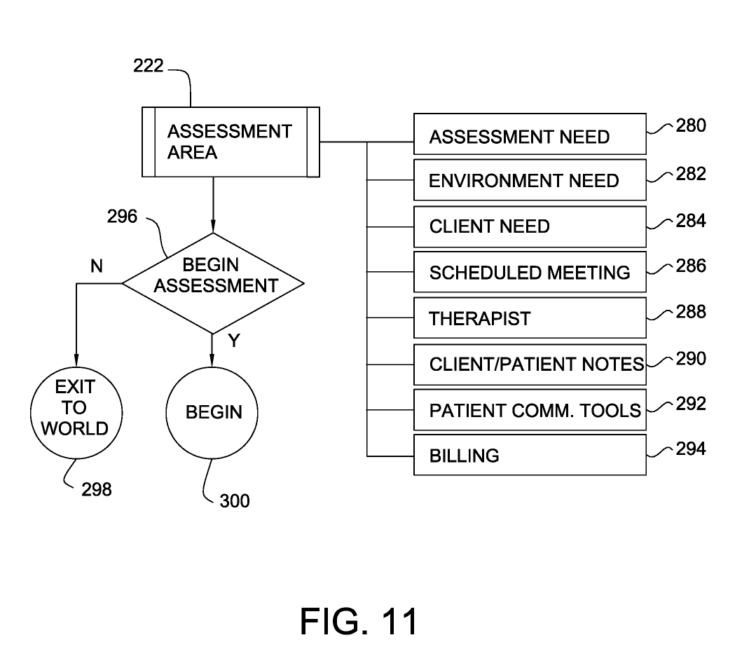

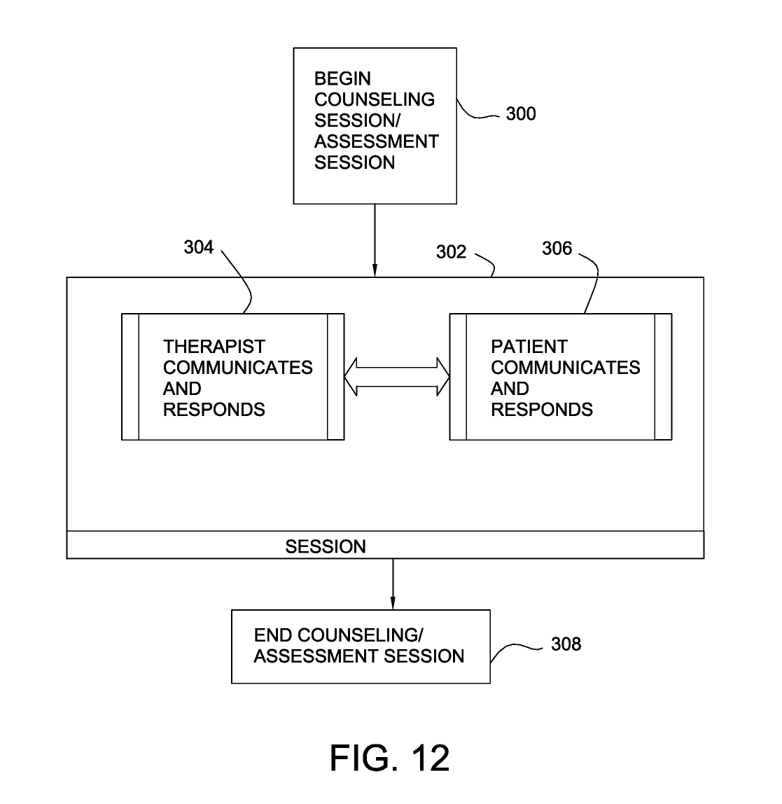

Referring to FIG. 11, the patient or client has entered into the professional area 128 and accessed the assessment area 222 object available in the professional services objects 200 as seen in FIG. 9. The patient as seen in FIG. 11 then has series of objects or hyperlinks or however it is set up, to choose from to enable an effective meeting between a therapist and the client. This includes making an assessment need determination at step 280, an environmental need determination at step 282, uploading or accessing the client chart at step 284, scheduling a meeting at step 286, contacting a therapist at step 288, accessing and uploading client patient notes at step 290, enabling various patient communication tools at step 292, which include the previously mentioned tool sets objects 174 as seen in FIG. 8. Additionally, the patient may need to enter in his billing information at step 294. After the patient has in this case entered his or her desired information and scheduled an assessment meeting, the patient is querried whether or not to begin the assessment at step 296. If it is time to begin the assessment, then the patient will begin the counseling session assessment session at step 300 as seen in FIG. 12, otherwise he will exit to the virtual counseling world at step 298 until it is time to begin the session.

Referring now to FIG. 12, the counseling session will begin at step 300 and the session occurs at step 302. Within the session, the therapist communicates and responds at step 304 and the patient communicates and responds at step 306, each utilizing their various tool sets and other accessible object-oriented data to effectively communicate.

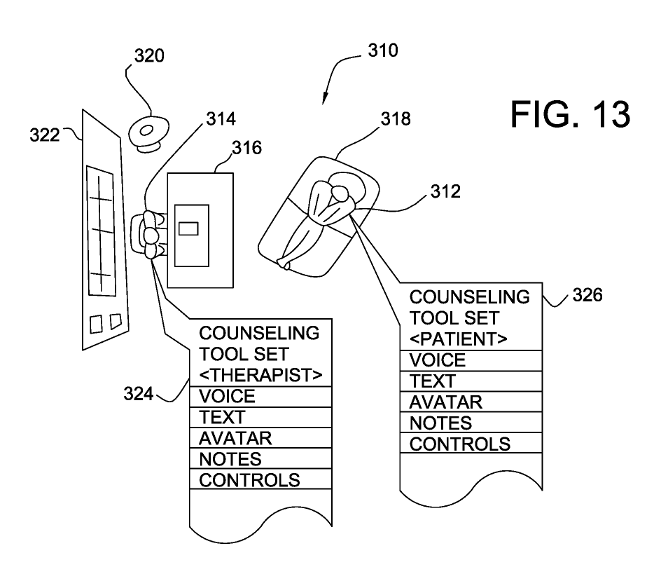

Referring to FIG. 13, an example of an instance of the virtual counseling world assessment session environment 310 is shown. Here the therapist Avatar 314 is sitting in a chair at any typical therapist desk 316. The therapist has chosen a traditional counseling session environment which includes a lamp 320 as well as an office wall 322 with a window and various accreditation information on the wall. The therapist Avatar 314 has various counseling tool sets available 324 at his disposal including voice, text, Avatar tools, notes, and other session controls.

Similarly the patient Avatar 312 has chosen to include in the virtual counseling world assessment session environment 310 a lounge chair 318 so that his Avatar can express a visual feeling of relaxation. The patient Avatar 312 has at his disposal certain counseling tool sets 326 including voice, text, Avatar controls, notes, and other controls within the counseling session. The patient and the therapist may choose to make notes and record the entire session in somewhat of a QuickTime movie or not depending on the confidentiality requirements. Once the session is complete, in referring to FIG. 12, the counseling session will end at step 308 and the therapist will be able to return to the professional therapist counseling offices area 212 to make his notes and determination for saving the session information for digestion by various health professionals such as doctors, other mental health colleagues, insurance companies, psychiatrists, and other individuals.

The patient Avatar may then go back to a personal area 126 to do further research on his own or may go to a peer-to-peer area 124 for desired interaction and communication with other like-minded patients.

The QuickTime movie can be uploaded into the file server and utilized by outside world professionals as previously discussed in the patient data virtual counseling world platform 36 as seen in FIG. 2.

Multiple instances of the above system can be initialized depending on the desired objective as can be further conceived.

While the present invention is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicants' general concept.

Therefore I claim:

1. A virtual counseling practice comprising:
a. a counselor trained to provide counseling to a patient, a counseling support service comprising a counseling server, a counseling application, and a counseling database;
b. said counseling application configured to provide virtual reality communication tools for operation within a virtual reality world, said virtual reality communication tools configured to provide communication between said counselor and said patient;
c. said virtual reality communication tools comprising a first group of strong intensity feeling objects, a first group of moderate intensity feeling objects, a first group of mild intensity feeling objects.

2. The counseling practice according to claim 1 wherein said virtual reality communication tools further comprise a first set of counseling object tools comprising:
a. an avatar object providing a choice of avatar representation for said counselor or said patient;
b. a voice object providing a choice of voice representation for said counselor or said patient;
c. a facial expression object providing a choice of facial representations for said counselor or said patient;
d. a body language object providing a choice of body language representation for said counselor or said patient;
e. an environment object providing a choice of environmental settings for said counselor or said patient;
f. a textual communication object providing a choice of textual communications for said counselor or said patient;
g. a feeling communication object providing a choice of feelings for said counselor or said patient to express within said virtual reality world.

3. The counseling practice according to claim 2 wherein said feeling communication object further comprises: a first group of feeling objects configured to combine one or more of said virtual reality objects for expression of a unique combination of avatar, voice, facial, body language, environment, and textual information to express feelings.

4. A virtual counseling practice comprising:
a. a first group of counselors trained to provide counseling to a first group of patients, a counseling support service comprising a counseling server, a first group of counseling applications, and a first group of counseling databases; said first group of counseling applications further comprising:
b. a first counselor application configured to provide said first group of counselors virtual reality counseling object tools enabling said first group of counselors to practice counseling between said first group of counselors and said first group of patients;
c. a first patient application configured to provide said first group of patients virtual reality patient object tools enabling said first group of patients to receive in said virtual reality world, counseling from said first group of counselors.

5. The counseling practice according to claim 4 wherein said virtual reality counseling object tools further comprises:
a. a counselor avatar object providing a choice of avatar representation for said first group of counselors;
b. a counselor voice object providing a choice of voice representation for said first group of counselors;
c. a counselor facial expression object providing a choice of facial representations for said first group of counselors;
d. a counselor body language object providing a choice of body language representation for said first group of counselors;
e. a counselor environment object providing a choice of environmental setting for said first group of counselors;
f. a counselor textual communication object providing a choice of textual communications for said first group of counselors;
g. a counselor feeling communication object providing a choice of feelings for said first group of counselors to express within said virtual reality world.

6. The counseling practice according to claim 4 wherein said virtual reality patient object tools further comprises:
a. a patient avatar object providing a choice of avatar representation for said first group of patients;
b. a patient voice object providing a choice of voice representation for said first group of patients;
c. a patient facial expression object providing a choice of facial representations for said first group of patients;
d. a patient body language object providing a choice of body language representation for said first group of patients;
e. a patient environment object providing a choice of environmental settings for said first group of patients;
f. a patient textual communication object providing a choice of textual communications for said first group of patients;
g. a patient feeling communication object providing a choice of feelings for said first group of patients to express within said virtual reality world.

7. The counseling practice according to claim 5 wherein said counselor feeling communication object further comprises: a first group of counselor feeling objects configured to combine one or more of said virtual reality counselor objects for expression of a first set of unique counselor feelings.

8. The counseling practice according to claim 6 wherein said patient feeling communication object further comprises: a first group of patient feeling objects configured to combine one or more of said virtual reality patient objects for expression of a first set of unique patient feelings.

9. The counseling practice according to claim 7 wherein said first group of counselor feeling objects comprises: a first group of strong counselor intensity feeling objects; a first group of moderate counselor intensity feeling objects; a first group of mild counselor intensity feeling objects.

10. The counseling practice according to claim 8 wherein said first group of patient feeling objects comprises: a first group of strong patient intensity feeling objects; a first group of moderate patient intensity feeling objects; a first group of mild patient intensity feeling objects.

11. A virtual counseling practice comprising:
a. a counseling server comprising a first group of counseling applications, said counseling applications comprising: a first administration application, a first patient application, a first counseling application;
b. said counseling server further comprising a first counseling database, said first counseling database comprising: a first administration database correlated to said first group of counseling applications, a first patient database correlated to said first group of counseling applications, a first counselor database correlated to said first group of counseling applications;
c. said practice further comprising: a first group of administrator's having access to a first administration client, said first administration client executing an instance of said first administration application; a first group of patients having access to a first patient client, said first patient client executing an instance of said first patient application; and a first group of counselors having access to a first provider client, said first provider client executing an instance of said first counseling application.

12. A virtual counseling method comprising:
a. starting a virtual counseling session within a virtual counseling world, said virtual counseling session comprising a counselor and a patient;
b. providing a first set of virtual reality communication tools for said counselor and said patient to use in said virtual counseling session;
c. providing a first set of counseling object tools within said virtual communication tools, said counselor or said patient utilizing said counseling object tools by:
i. choosing an avatar object resident within said virtual counseling world;
ii. choosing a voice object resident within said virtual counseling world;
iii. choosing a facial expression object resident within said virtual counseling world;
iv. choosing a body language object resident within said virtual counseling world;
v. choosing an environmental object resident within said virtual counseling world;
vi. choosing a textual communication object resident within said virtual counseling world;
vii. choosing a feeling communication object resident within said virtual counseling world;
d. combining one or more of said counseling object tools for expression of a unique combination of avatar, voice, facial, body language, environment, and textual information to express feelings during said virtual counseling session.

13. A virtual counseling practice comprising:
a. means for starting a virtual counseling session within a virtual counseling world, said virtual counseling session comprising a counselor and a patient;
b. means for providing a first set of virtual reality communication tools for said counselor and said patient to use in said virtual counseling session;
c. means for providing a first set of counseling object tools within said virtual communication tools, said counselor or said patient accessing said counseling object tools to communicate during said counseling session.

14. The counseling practice according to claim 13 wherein said practice further comprises said counselor or said patient accessing said counseling object tools by utilizing:
a. means for choosing an avatar object resident within said virtual counseling world;
b. means for choosing a voice object resident within said virtual counseling world;
c. means for choosing a facial expression object resident within said virtual counseling world;
d. means for choosing a body language object resident within said virtual counseling world;
e. means for choosing an environmental object resident within said virtual counseling world;
f. means for choosing a textual communication object resident within said virtual counseling world;
g. means for choosing a feeling communication object resident within said virtual counseling world;
h. means for combining one or more of said counseling object tools for expression of a unique combination of avatar, voice, facial, body language, environment, and textual information to express feelings during said virtual counseling session.

15. A virtual counseling practice comprising:
a. a first group of counselors trained to provide counseling to a first group of counselees, a counseling support service comprising a counseling server, a first group of counseling applications, and a first group of counseling databases; said first group of counseling applications further comprising:
b. a first counselor application configured to provide said first group of counselors virtual reality counseling object tools enabling said first group of counselors to practice counseling between said first group of counselors and said first group of counselees;
c. a first counselee application configured to provide said first group of counselees virtual reality counselee object tools enabling said first group of counselees to receive in said virtual reality world, counseling from said first group of counselors.
